(19) United States
(12) Patent Application Publication
(10) Pub. No.: US 2014/0224241 A1
(43) Pub. Date: Aug. 14, 2014

(54) Kamado style cooker and fireplace

(71) Applicant: John Milner McCary, Birmingham, AL (US)

(72) Inventor: John Milner McCary, Birmingham, AL (US)

(21) Appl. No.: 13/815,242

(22) Filed: Feb. 13, 2013

(51) Int. Cl. A47J 37/07

(52) U.S. Cl. CPC A47J 37/0704
USPC 126/25 R

(57) ABSTRACT

A combination manufactured Kamado style insulated cooker and fireplace with fireplace door or doors on the front lower section of the Kamado/cooker. The fireplace doors can be opened to give access to place, attend and remove fuel burning sources, including gas logs and food items. When the fireplace door or doors are closed the Kamado grill/cooker/smoker/baking, top and lower section, can perform all functions and capabilities of a conventional Kamado cooker. The use of the fireplace and Kamado cooking can be used simultaneously but the insulation properties and control of air flow in Kamado style cooking may be reduced when the fireplace door(s) or top lid/chimney is opened or kept open.

### BACKGROUND OF THE INVENTION

1. Field of the Invention

The present invention relates to a combination kamado style insulated cooker combined with an outdoor fireplace.

2. Description of the Prior Art

Kamado style grills have been in usage for thousands of years. Kamado is a Japanese word for a traditional earthenware cooking vessel. Today Kamado cookers are widely known as ceramic or insulated grills. Typically these grill/smokers are made of ceramic shells, some a combination of metal and insulation and others use a variety of stone like material. The construction materials and good air control gives these grills excellent insulation, high heating efficiency, and the ability to hold very high and very low temperatures, making them very good for grilling and smoking. Kamado grill/cookers also have efficient air control dampers, usually at the bottom and at the top of the cookers.

Comparing traditional metal grills to Kamado grill/smokers, metal grills are usually not insulated and need to continually burn more fuel to maintain the desired cooking temperature. As more air is brought in to the metal cooker needed by the burner or burned fuel to maintain the desired heat level, a draft is created that carries out much of the moisture and juices of the cooked food.

Outdoor fireplace style cookers have also been in existence for thousands of years, where primarily food is cooked outside. Outdoor fireplaces have become a desired addition to many homes in recent years where the usage of the fireplace includes a place where friends and family can enjoy the warmth in front of a glowing fire. Combining comfort and warmth, the outdoor fireplace allows one to be outside more months of the year as a gathering spot. One is usually able to cook on the outdoor fireplace plus kids enjoy roasting hotdogs, marshmallows or other food items in the open flames.

Kamado grills usually burn charcoal but also customarily burn wood pellets and, on occasion, gas. Once the charcoal or other fuel is placed down in the lower section of the Kamado cooker it is not that easy to access, attend, add or remove the fuel, especially once the cooking grill is place on the Kamado cooker. There is usually no significant horizontal/lateral access to the lower fuel burning section of the Kamado cooker.

In U.S. Application No. 20050121018 the cooker has the ability to add a fireplace/fire pit to a grill/smoker assembly but the grill/smoker and the fireplace/fire pit components are not manufactured permanently combined. Also the grill/cooker is not an insulated Kamado style heat containing cooker.

There is a need for a manufactured combined Kamado style insulated grill/smoker and fireplace. The benefits of each could be enjoyed in use individually or the use of the Kamado grill cooker and the outdoor fireplace usage can be used simultaneously. The combination Kamado style cooker and fireplace could have cost and space savings to the user by not having to purchase two separate units plus the possibility of using same burning fuel in same time combination usages.

### BRIEF SUMMARY OF THE INVENTION

The present invention is a manufactured together Kamado style grill/smoker combined with a fireplace/cooker. The Kamado cooker and the fireplace is manufactured such that the function of each respective usage functions and qualities are maintained. The fireplace has two air sealable insulated door or doors on the front lower section of the Kamado style cooker. With the fireplace door(s) open burning sources and food can be added, attended to and removed. Food racks or fuel burning holders can be placed in the Lower section of the Kamado cooker/fireplace. When the door(s) are closed the Kamado cooker/fireplace becomes almost if not fully insulated with all the cooking functions and capabilities of a conventional Kamado cooker. The use of the open door(s) fireplace, either just enjoying the warmth and/or cooking in the fireplace, can be performed simultaneously with the use of the Kamado top grill/smoker but there may be some loss in fuel burning, air and heat control. The insulation qualities of the combination Kamado style cooker and fireplace allows the rear and sides of the combination cooker to be fairly close to flammable material, such as wood siding or wood deck, without heat build up on the close proximity flammable material, especially when the fireplace is used.

### BRIEF DESCRIPTION OF THE KAMADO COOKER/FIREPLACE

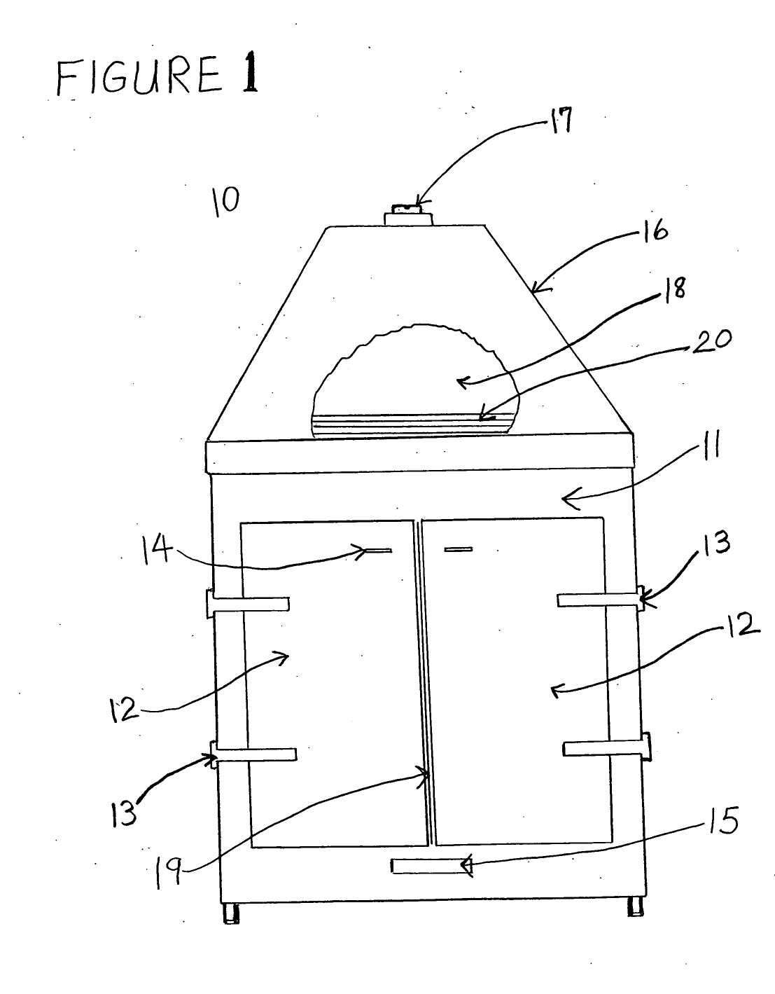

FIG. 1 Shows in a front perspective view of the Kamado cooker/fireplace with the fireplace doors closed.

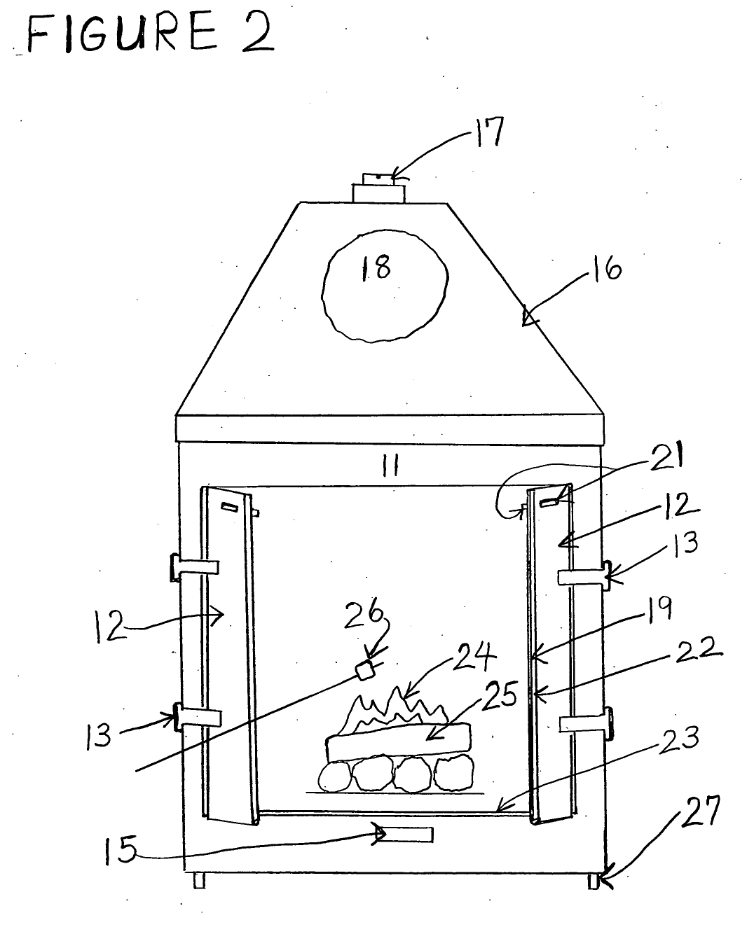

FIG. 2 A front perspective view of combination Kamado cooker/fireplace with the fireplace doors open, logs and/or charcoal fuel burning and food/marshmallows being cooked, within the fireplace section, the top lid, chimney/air control damper and Kamado style grill cooking area.

### DETAILED DESCRIPTION OF THE INVENTION

Shown in FIG. 1, in a front perspective view, is the combination Kamado cooker/smoker and fireplace 10. In the lower section 11 of the Kamado cooker/fireplace are the closed fireplace doors 12 with the door hinges 13 and door opener/closers 14. Below the doors is the intake air control damper/ash cleanout 15. The lid 16 and chimney/upper air damper 17 are shown in the Kamado style cooking area 18. Fire resistant material 19 helps to seal air movement through the fireplace doors 12 when closed and secured by the door opener/closers 14. Pictured inside the lid 16 is the cooking grill 20 for Kamado style cooking/grilling/smoking.

FIG. 2 shows in a front perspective view the combination Kamado cooker/smoker and fireplace with the fireplace doors 12 opened. The inside part of the door opener/closer 21 and hinges 13 can be seen. Fire resistant air seal material 18 is shown adhered on the door edges 22 or on the circumference of the opening 23 of the lower fireplace section 11. The flaming fire 24 is seen above the burning fuel 25, such as charcoal or wooden logs, and food/marshmallows 26 being cooked over the fire 24. Also shown are extensions 27 from possible inside or outside metal linings to be and/or give support to, the base, feet and/or attaching point for transport wheels. The intake air damper/ash cleanout 15 is shown below the lower fireplace section 11. The lid 16 and chimney/upper air damper 17 are shown as part of the upper Kamado style cooking area 18.

1. A combination manufactured Kamado style insulated cooker and fireplace, compromising:
a. a lower insulated, ceramic, or insulated metal lined on one side of insulation or metal lining on both sides of insulation, fuel burning/cooking fireplace section with able to open access door or doors and an air intake damper/ash cleanout; and
b. an upper insulated, ceramic, or insulated metal lined on one side of insulation or metal lining on both sides of insulation, Kamado style grill/cooker section with a lid and chimney/air control damper; and
c. when the fireplace door or doors are opened one is able to place, attend, remove fuel burning sources, such as charcoal, wood, and gas logs, and place, attend or remove food items in the fireplace section; and
d. when the fireplace door or doors are closed and most, if not all, air is sealed at the door(s) seams by fire resistant material, significantly all grilling, cooking, baking or smoking capabilities and functions of a conventional Kamado cooker can be performed; and
e. wherein the fireplace and the Kamado grill/cooker cooking can be used as separate time use functions or used simultaneously but some control of heat insulation and air flow control may be reduced when the fireplace door(s) and/or the top lid/chimney is opened or left open; and
f. the insulation qualities of the combination Kamado style cooker and fireplace allows the rear and sides of the combination cooker to be fairly close to flammable material, such as wood siding or wood deck, without significant heat build up to the close proximity flammable material, especially when the fireplace is used.

2. A combination manufactured Kamado style insulated cooker and fireplace according to claim 1, wherein a metal lining, food racks or burning fuel/gas log holders may be placed and possibly removed within the lower fireplace section.

3. A combination manufactured Kamado style insulated cooker and fireplace according to claim 1, where an extension of the metal lining on the inside and/or outside of the lower fireplace section insulation to be and/or give support to, the base, feet or attaching point for transport wheels.
